(19) United States
(12) Patent Application Publication
(10) Pub. No.: US 2014/0293853 A1
(43) Pub. Date: Oct. 2, 2014

(54) METHOD FOR TRANSMITTING MACHINE TYPE COMMUNICATION DATA AND APPARATUS FOR THE SAME

(71) Applicant: Electronics and Telecommunications Research Institute, Daejeon (KR)

(72) Inventors: Dae Soon CHO, Daejeon (KR); Choon Woo SHIN, Daejeon (KR); Il Gyu KIM, Chungcheongbuk-Do (KR)

(73) Assignee: Electronics and Telecommunications Research Institute, Daejeon (KR)

(21) Appl. No.: 14/224,723

(22) Filed: Mar. 25, 2014

(30) Foreign Application Priority Data
Mar. 27, 2013 (KR) 10-2013-0032633

(51) Int. Cl. H04W 56/00; H04W 52/02

(52) U.S. Cl. CPC H04W 56/0045; H04W 52/0212
USPC 370/311

(57) ABSTRACT

A method for transmitting machine type communication (MTC) data and an apparatus therefor are disclosed. A method for transmitting data in a MTC device located in a mobile communication system may comprise estimating an absolute position of the MTC device, receiving an awake message, extracting downlink synchronization information and absolute positional information of a base station included in the awake message, estimating a transmission delay time between the MTC device and the base station, and transmitting signal to the base station based on the transmission delay time and the downlink synchronization information. Therefore, a problem of uplink interferences between terminals and a base station due to a MTC device, which can be generated in supporting MTC services for a conventional cellular communication system, may be resolved.

### CLAIM FOR PRIORITY

This application claims priority to and the benefit of Korean Patent Application No. 10-2013-0032633 filed on Mar. 27, 2013 in the Korean Intellectual Property Office (KIPO), the entire contents of which are hereby incorporated by references.

### BACKGROUND

1. Technical Field

Example embodiments of the present invention relate to a method for transmitting data in a machine type communication device, and more specifically to a machine type communication device using the same, a method for controlling a machine type communication device using the same, and an apparatus using the same.

2. Related Art

Machine type communication (MTC) or machine to machine communication (M2M) denotes a type of data communication associated with at least one entity that does not necessarily require human intervention.

Services that are optimized for MTC are different from services that are optimized for human-to-human communication, and are characterized differently from current mobile network communication in that the services are associated with characteristics such as a) a variety of market scenarios, b) data communication, c) lower costs and effort, d) a significantly large number of potential terminals that communicate, and e) a significantly small amount of traffic for each terminal up to a large range.

MTC may be exhibited in the form of various services, and as examples of the various services, smart metering, tracking and tracing, remote maintenance and control, e-Health, and the like, may be given. In current 3rd generation partnership project (3GPP), standardization of MTC for intelligent communication in human-to-object and object-to-object is in progress.

The representative issues related to MTC which are being considered in current 3GPP Long Term Evolution (LTE) are how to make low-priced MTC devices. For the above purpose, a Radio Frequency (RF) design and a baseband modem design suitable for MTC are being studied.

In order to design low-priced MTC devices, designing narrow band MTC device is considered as a representative option. Frequency bands 1.4 MHz to 5 MHz are focused upon mainly, and configuration of frequency bands used for MTC device may be dependent upon traffic characteristics of application domain for which the MTC device is used.

The most favorable candidate technique for designing low-priced narrowband MTC device is a technique of using a fixed narrow frequency band and a single RF transceiver for the same. However, it becomes difficult to achieve frequency diversity gain and receive diversity gain when narrow band device is implemented. Also, using a fixed narrow frequency band may make cell coverage smaller. The reduction of cell coverage may be problems for both uplink and downlink.

Therefore, methods for maintaining cell coverage as identical to that of conventional LTE legacy systems are required even when MTC device is implemented as narrow frequency band device.

Recently, in a market of next generation communications targeting ubiquitous network environment such as smart metering, remote sensing, etc., the need for providing machine to machine communication services or machine type communication services is becoming raised.

When conventional cellular communication system is used to provide such the MTC services, signals from MTC devices which are not synchronized with a base station may generate significant interferences on uplink channels between terminals and the base station.

### SUMMARY

Accordingly, example embodiments of the present invention are provided to substantially obviate one or more problems due to limitations and disadvantages of the related art.

Example embodiments of the present invention provide a method for transmitting data in a MTC device, in which an efficient uplink time synchronization procedure is used.

Example embodiments of the present invention also provide a MTC device using a method for transmitting data in a MTC device, in which an efficient uplink time synchronization procedure is used

Example embodiments of the present invention also provide a method for controlling MTC device, which is performed in a MTC aggregator.

Example embodiments of the present invention also provide a MTC aggregator using a method for controlling MTC device.

In some example embodiments, there is provided a method for transmitting data in a machine type communication (MTC) device located in a mobile communication system, the method comprising: estimating an absolute position of the MTC device, receiving an awake message, extracting downlink synchronization information and an absolute position of a base station included in the awake message, estimating a transmission delay time between the MTC device and the base station, and transmitting signal to the base station based on the transmission delay time and the downlink synchronization information.

Here, the transmission delay time may be calculated using the absolute position of the MTC device and the absolute position of the base station.

Here, the downlink synchronization information may include information related to frame synchronization and symbol synchronization.

Here, the MTC device may be belonging to a group with at least one MTC device located in a predetermined distance from the MTC device.

Also, MTC devices belonging to the same group may be configured to process data having the same property.

Also, the mobile communication system may be based on an Orthogonal Frequency Division Multiplexing (OFDM).

Also, the group may comprise at least two MTC devices located in a range in which transmission delay time between the at least two MTC devices is shorter than a time length of cyclic prefix (CP).

Also, the awake message may be received from a MTC aggregator belonging to the same group with the MTC device.

In other example embodiments, there is provided a MTC device comprising: a position estimating part estimating an absolute position of the MTC device, and a control part estimating a transmission delay time between the MTC device and a base station by extracting downlink synchronization information and an absolute position of the base station included in an awake message when the awake message is received.

Here, the MTC device may further comprise a transceiving part configured to receive the awake message, and transmit signal to the base station using the transmission delay time and the downlink synchronization information.

Here, the control part may be configured to maintain a state of the MTC device as a sleep-state before the MTC device receives the awake message.

Here, the awake message may be received from a MTC aggregator belonging to the same group with the MTC device.

In still other example embodiments, there is provided a method for controlling a plurality of machine type communication (MTC) devices belonging to a same group, performed in a MTC aggregator, the method comprising: estimating an absolute position of the MTC aggregator, performing a downlink synchronization with a base station, and receiving an absolute position of the base station from the base station, and transmitting an wake message to at least one of the plurality of MTC devices when data transmission to the at least one of the plurality of MTC devices is required.

Here, the same group may include a plurality of MTC devices and the MTC aggregator which are located in a predetermined distance from each other.

Here, the downlink synchronization information may include information related to frame synchronization and symbol synchronization.

Here, MTC devices belonging to the same group may be configure to process data having the same property.

Here, the base station, the plurality of MTC devices, and the MTC aggregator may be based on an Orthogonal Frequency Division Multiplexing (OFDM).

Also, transmission delay times between the MTC aggregator and each of MTC devices belonging to the same group with the MTC aggregator may be shorter than a time length of cyclic prefix (CP).

### BRIEF DESCRIPTION OF DRAWINGS

Example embodiments of the present invention will become more apparent by describing in detail example embodiments of the present invention with reference to the accompanying drawings, in which:

FIG. 1 is a conceptual diagram of a mobile communication network providing MTC services according to the present invention;

FIG. 2 is a conceptual diagram to show effect of uplink interferences caused by a MTC device which is not synchronized with a base station;

FIG. 3 is a conceptual diagram to show effects of interferences in an uplink frame structure respectively when a terminal is synchronized with a base station and when a terminal is not synchronized with a base station;

FIG. 4 is a conceptual diagram to show a concept of time alignment between a terminal and a base station using timing advance mechanism;

FIG. 5 is a conceptual diagram to illustrate a method of uplink time synchronization of MTC device according to the present invention;

FIG. 6 is a flow chart to illustrate a method for uplink time synchronization of MTC device according to an example embodiment of the present invention;

FIG. 7 is a flow chart to explain a method for transmitting data in a MTC device according to an example embodiment of the present invention;

FIG. 8 is a flow chart to explain a method for controlling MTC device according to an example embodiment of the present invention;

FIG. 9 is a block diagram to illustrate a configuration of MTC device according to an example embodiment of the present invention; and

FIG. 10 is a block diagram to illustrate a configuration of a MTC aggregator according to an example embodiment of the present invention.

### DESCRIPTION OF EXAMPLE EMBODIMENTS

Example embodiments of the present invention are disclosed herein. However, specific structural and functional details disclosed herein are merely representative for purposes of describing example embodiments of the present invention, however, example embodiments of the present invention may be embodied in many alternate forms and should not be construed as limited to example embodiments of the present invention set forth herein.

Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention. Like numbers refer to like elements throughout the description of the figures.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The term “terminal” used in this specification may be referred to as User Equipment (UE), a User Terminal (UT), a wireless terminal, an Access Terminal (AT), a Subscriber Unit (SU), a Subscriber Station (SS), a wireless device, a wireless communication device, a Wireless Transmit/Receive Unit (WTRU), a mobile node, a mobile, or other words. The terminal may be a cellular phone, a smart phone having a wireless communication function, a Personal Digital Assistant (PDA) having a wireless communication function, a wireless modem, a portable computer having a wireless communication function, a photographing device such as a digital camera having a wireless communication function, a gaming device having a wireless communication function, a music storing and playing appliance having a wireless communication function, an Internet home appliance capable of wireless Internet access and browsing, or also a portable unit or terminal having a combination of such functions. However, the terminal is not limited to the above-mentioned units.

Meanwhile, to distinguish between UE that is frequently used by users and UE that is used for a machine type communication (MTC) service, the UE used for an MTC service will be referred to as an “MTC device,” and the UE used for general and conventional communication between users other than MTC will be referred to as UE. Also, the term ‘MTC’ may be used as a general term for representing a machine type communication (MTC) and a machine to machine communication (M2M), without limiting its meaning to any specific standardization organization or any standard specification.

Also, the term “base station” used in this specification means a fixed point that communicates with terminals, and may be referred to as another word, such as Node-B, eNode-B, a base transceiver system (BTS), an access point, etc. Also, the term “base station” means a controlling apparatus which controls at least one cell. In a real wireless communication system, a base station may be connected to and controls a plurality of cells physically, in this case, the base station may be regarded to comprise a plurality of logical base stations. That is, parameters configured to each cell are assigned by the corresponding base station.

Hereinafter, embodiments of the present invention will be described in detail with reference to the appended drawings. In the following description, for easy understanding, like numbers refer to like elements throughout the description of the figures, and the same elements will not be described further.

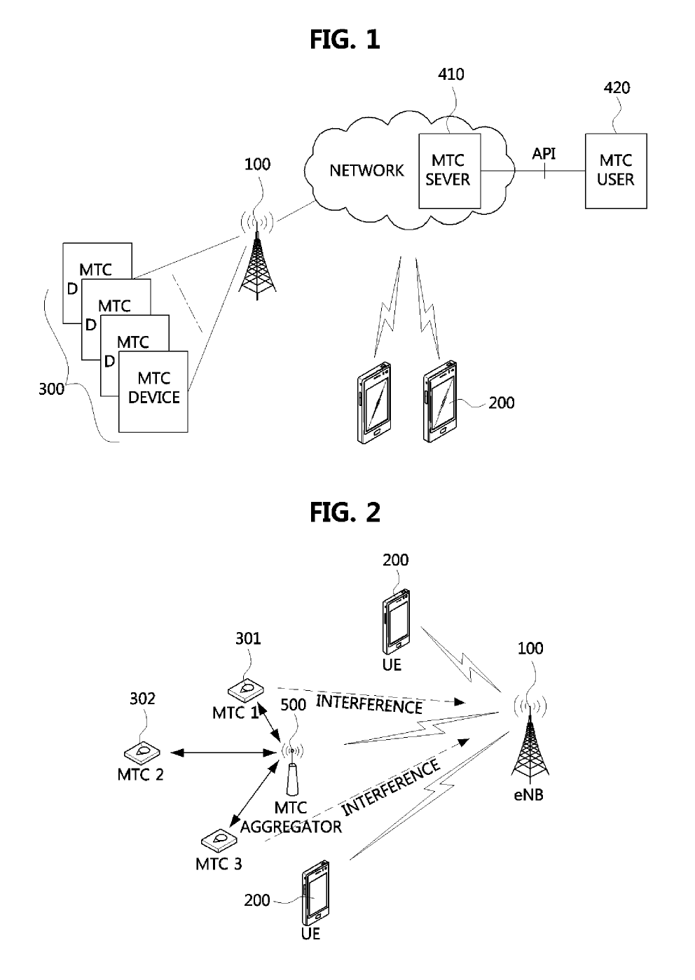

FIG. 1 is a conceptual diagram of a mobile communication network providing MTC services according to the present invention.

As shown in FIG. 1, the mobile communication network providing MTC services may comprise a base station 100 and a UE 200 as entities for conventional mobile communication network. In addition, the mobile communication network providing MTC services may further comprise a MTC server 410 for providing MTC services, a MTC user 420, at least one MTC device 300, etc.

The MTC device 300 is a terminal device having a function of MTC, which communicates with the MTC server and other MTC devices through a Public Land Mobile Network (PLMN).

The MTC server 410 may communicate with the PLMN, and communicate with the MTC device 300 via the PLMN. Also, the MTC server 410 may have an interface which the MTC user 420 can access, and provide services for the MTC user 420. The MTC user 420 uses services provided by the MTC server 410.

In a configuration of FIG. 1, the MTC server 410 may be controlled by a network operator. The network operator may provide Application Programming Interface (API) on the MTC server 410, and the MTC user 420 may access the MTC server of the network operator by using the API.

Meanwhile, an example in which the MTC server is shown as included in a network operator domain is shown in FIG. 1. However, the MTC server may be located out of the network operator domain. In this case, the MTC service may not be controlled by the network operator.

Also, the MTC device 300 may communicate with the MTC server 410 located in the network through the base station 100.

In order to provide machine type communication services through the mobile communication system illustrated in FIG. 1, fluent interoperability in radio access between the MTC device and the mobile communication system is becoming necessary. Therefore, characteristics, especially related to frequency bandwidth, of mobile communication network interoperating with MTC device should be studied.

Also, when a great number of MTC devices are disposed in a cellular communication network shown in FIG. 1, signals of MTC devices which are not synchronized with the base station may generate significant interferences on uplink channel.

FIG. 2 is a conceptual diagram to show effect of uplink interferences caused by a MTC device which is not synchronized with a base station.

As shown in FIG. 2, when uplink synchronizations between the base station 100 and MTC devices 301 to 303 are not established, signals transmitted by the MTC devices may generate interferences on uplink communications between the UE 200 and the base station communicating with each other through a conventional cellular communication network.

In a Wireless Personal Area Network (WPAN) communications such as ZigBee, Bluetooth, and the like, since transmission power is relatively lower and an unlicensed band such as an Industrial, Science, and Medical (ISM) band is used for the communications, effects due to interference are not so significant.

However, an existing 2 GHz licensed band is used for MTC applied to cellular communication network in order to extend a transmission range to several kilometers, and so it becomes necessary to use higher transmission power. Accordingly, interferences on uplink of cellular network are generated by MTC devices as shown in FIG. 2 unlike the WPAN devices. These problems should be overcome.

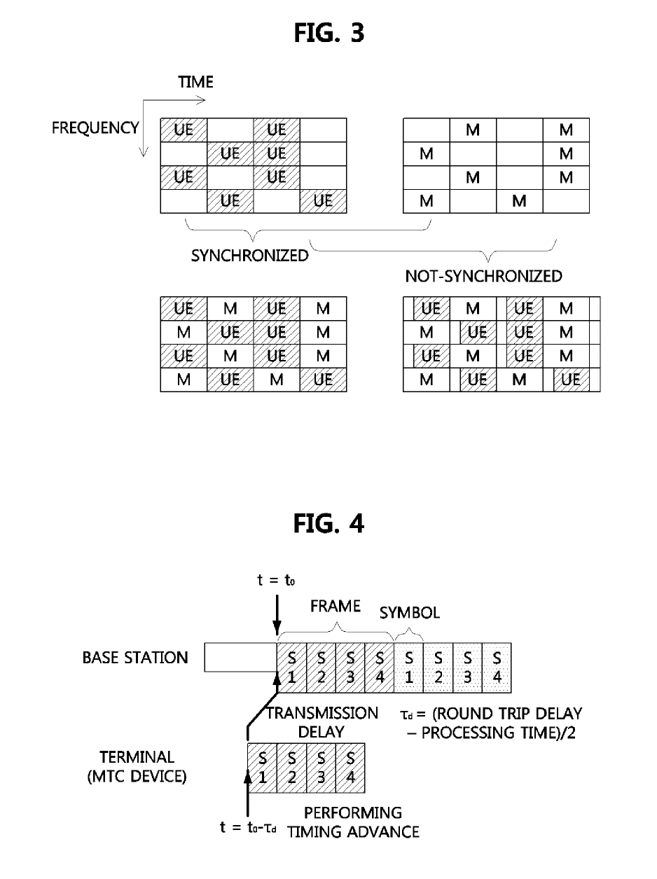

FIG. 3 is a conceptual diagram to show effects of interferences in an uplink frame structure respectively when a terminal is synchronized with a base station and when a terminal is not synchronized with a base station.

The frame structure shown in FIG. 3 represents a structure of uplink frame used for a UE or a MTC device to transmit data to a base station in a cellular communication network supporting MTC shown in FIG. 2. The horizontal axis of FIG. 3 represents time elapse, and the vertical axis of FIG. 3 represents frequency.

Each block in the uplink frame structure depicted in FIG. 3 may be corresponding to a block for resource allocation. As shown in an upper part of FIG. 3, blocks allocated for UE and blocks allocated for MTC devices are allocated separately so that they are not overlapped.

For example, a UE may transmit an uplink frame depicted in an upper left part of FIG. 3 to the base station, and a MTC device may transmit an uplink frame depicted in an upper right part of FIG. 3 to the base station. That is, the base station may receive uplink frames transmitted from each of the UE and the MTC device.

When appropriate orthogonal resources are allocated by an upper layer (L2 or L3 layer), uplink time and frequency synchronization should be established with a base station in an L1 layer so that a result depicted in a lower left part of FIG. 3 may be achieved. That is, a problem of interferences on uplink signal received in the base station may be resolved.

However, when MTC devices are synchronized with a base station, a result depicted in a lower right part of FIG. 3 may be occurred. Here, a problem of frequency synchronization may be overcome by low mobility characteristic of MTC devices and frequency domain equalization procedures. MTC devices which are not synchronized with a base station may generate significant interferences on uplink of cellular communication network.

FIG. 4 is a conceptual diagram to show a concept of time alignment between a terminal and a base station using timing advance mechanism.

In the conceptual diagram of FIG. 4, a MTC device (terminal) transmits an uplink frame comprising four symbols, and a base station receives the transmitted uplink frame after elapse of transmission delay time (τ_{d}).

An uplink time synchronization may be established by aligning signals of each terminal and each MTC device in reference to time axis of a base station. For this, information about a start time of a frame and a start time of a symbol in the base station, transmission delay time according to a distance between a base station and a MTC device or a UE is needed as shown in FIG. 4.

Specifically, when a start time of frame in the base station is assumed as t₀, a start time of frame in the terminal (MTC device) may be t₀-τ_{d}, a time ahead by τ_{d} as compared to the start time of frame in the base station. Here, a value τ_{d} may be determined as a value obtained by (a round trip delay time−a processing delay time)/2.

In a conventional cellular communication system, additional channel is allocated for obtaining such information required, and predetermined processes are performed persistently in order to acquire uplink synchronization with a base station.

A frame synchronization procedure for obtaining frame start time is performed by allocating separate downlink preamble and detecting the allocated preamble periodically by a terminal. Also, a symbol synchronization procedure may be performed through periodic detections of cyclic prefix (CP), and a transmission delay time estimation procedure may be performed by a base station, in which the base station estimates the transmission delay time using uplink random access channel allocated separately.

However, these procedures and allocation of the additional channels for the procedures are not conforming to properties which MTC devices have, the properties of low data usage, a property of simultaneous accesses from multiple MTC devices, and a property of low power supply.

Accordingly, uplink time synchronization for MTC services may require other methods except methods for uplink synchronization of conventional cellular communications.

For the sake of this, in the present invention, MTC devices may be grouped into groups in which MTC devices having near physical distances from each other participate by considering a property of group based optimization. MTC devices in the same group may perform communications with a base station through a MTC aggregator which has capability of communicating with a base station.

In addition, in the present invention, based on time synchronization protocol of MTC device using a MTC aggregator which will be explained in detail later, uplink time synchronization between a base station and MTC devices may be established without allocating random access resources for all MTC devices.

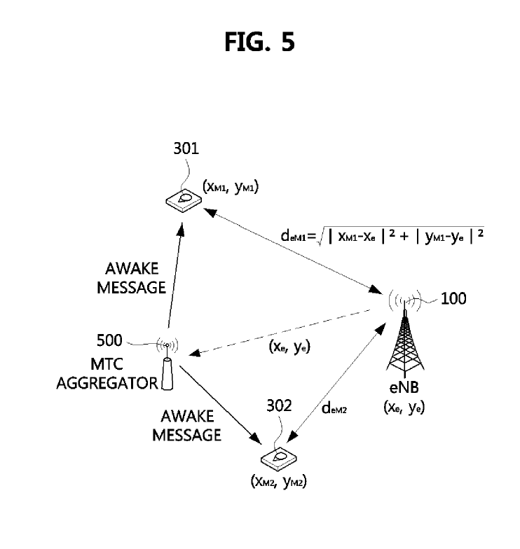

FIG. 5 is a conceptual diagram to illustrate a method of uplink time synchronization of MTC device according to the present invention.

A MTC device according to the present invention may comprise a function of communicating with a MTC aggregator 500 and a function of estimating position of itself.

Also, the MTC aggregator 500 among a plurality of MTC devices may be a device having capability of communicating with a base station 100. MTC devices belonging to corresponding group may transmit data to the base station through the MTC aggregator 500.

In addition, UEs or the base station 100 may be assumed to comprise basically the same function with devices of the conventional cellular communication system, and operate identically to the devices of the conventional cellular communication system.

In the present invention, at least one MTC aggregator and MTC devices which process data having similar properties and have near physical distances from each other may be grouped into the same group.

The MTC aggregator 500 which is a MTC device having a function of aggregator among a plurality of MTC devices constituting a group maintains frame and symbol synchronization with a base station like the conventional UEs. In addition, other MTC devices 301 and 302 may maintain sleep state for power saving until they receive awake message from the MTC aggregator.

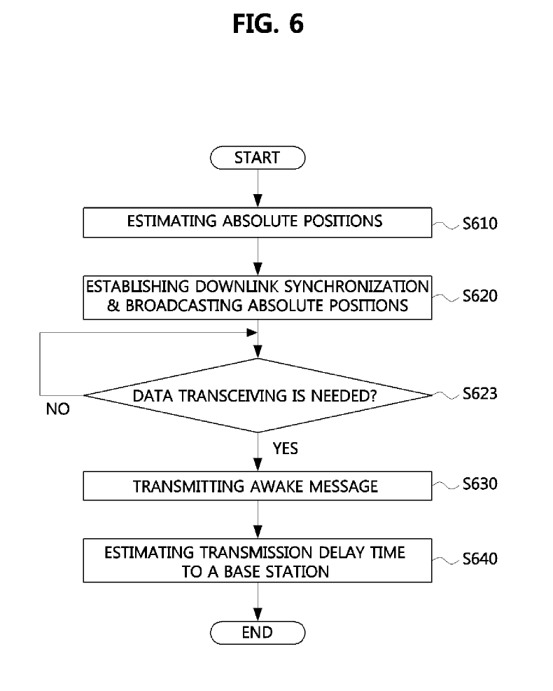

A method for uplink time synchronization of MTC device according to the present invention may comprise four steps broadly shown in FIG. 6.

FIG. 6 is a flow chart to illustrate a method for uplink time synchronization of MTC device according to an example embodiment of the present invention.

A first step S610 is a procedure of estimating absolute positions of each of MTC devices 301 and 302, a MTC aggregator 500, and a base station 100. For absolute position estimation, known methods in conventional ad-hoc sensor network, etc. may be used. According to low mobility property of MTC devices, the procedure of estimating absolute positions may be performed periodically with a long term period, and so may not result in bad effects in power efficiencies of MTC devices.

A second step S620 is a procedure of establishing downlink synchronization between the MTC aggregator 500 and the base station 100.

Specifically, in the second step, frame synchronization and symbol synchronization between the MTC aggregator 500 and the base station 100 may be established. Here, such the downlink synchronization procedure may be performed using a procedure of synchronization between a terminal and a base station in a conventional cellular communication.

In addition, in the second step S620, the base station may broadcast information about absolute position of the base station itself which was obtained in the first step S610 to the MTC aggregator 500. The broadcasting of information about the absolute position of the base station may be performed through a broadcasting channel appropriately allocated by the base station.

A third step S630 is a procedure in which a MTC user requests to transmit information to MTC devices 301 to 303 via the base station connected to a public land mobile network (PLMN), or the MTC aggregator 500 awakes other sleep state MTC devices 301 to 303 in a group when the MTC aggregator 500 senses changes of environment, that is, when the MTC aggregator 500 needs to transmit and receive data to or from other MTC devices 301 to 303 in a group.

Here, the MTC aggregator 500 may transmit the awake message with downlink synchronization information (frame synchronization information and symbol synchronization information) and the information about absolute position of the base station 100 which were obtained in the second step.

At this time, although the MTC devices 301 to 303 are in sleep states, they maintain a state in which they can receive the awake message from the MTC aggregator 500.

In the present invention, through the third step, other MTC devices except the MTC aggregator 500 may not perform periodic downlink synchronization procedures. Accordingly, an effect of power saving in the MTC devices may be achieved.

A fourth step S640 is a procedure in which each of the MTC devices 301 to 303 estimates transmission delay time between corresponding MTC device and the base station based on information obtained in the first step and the third step using below equation 1.

$${τ}_{eM 1} = \frac{{d}_{eM 1}}{C} = \frac{\sqrt{{\vert {x}_{e} - {x}_{M 1} \vert}^{2} + {\vert {y}_{e} - {y}_{M 1} \vert}^{2}}}{c} \qquad [ Equation 1 ]$$

In the equation 1, τ_{eM1} may mean a transmission delay time between the base station 100 and a first MTC device 301 as shown in FIG. 1. Also, (xₑ, yₑ) may be a coordinate representing an absolute position of the base station 100, and (x_{M1}, y_{M1}) may be a coordinate representing an absolute position of the first MTC device 301.

Here, c=3.0×10⁸ m/s

Each of MTC devices may transmit signal at appropriate time obtained based on the transmission delay time computed using the equation 1 and the frame and symbol synchronization information obtained from the MTC aggregator 500.

Such the signal transmission according to the present invention may make uplink synchronization between MTC devices and the base station possible. Thus, signals transmitted from the MTC devices may be aligned in time of the base station as shown in FIG. 3.

However, according to transmission delay times between the MTC devices 301 to 303 and the MTC aggregator 500, signals arrived in the MTC aggregator 500 may not be synchronized, that is, may not be time-aligned.

In order to solve the above problem, in the present invention, a range of application of a method for uplink synchronization according to the present invention may be limited to an orthogonal frequency division multiplexing (OFDM) system. In other words, transmission delay times between them should be considered in grouping MTC devices and MTC aggregators. For example, transmission delay times between each of the MTC devices 301 and 302 and the MTC aggregator 500 in the same group may be shorter than time length of cyclic prefix.

Thereby, differences of transmission delay times may be applied to phase changes of frequency domain channel as shown in below equation 2. Also, the above problem may be solved by frequency domain equalization.

$$x ( n - m ) ↔ {e}^{- j \frac{2 π m}{N}} X ( k ) \qquad [ Equation 2 ]$$

In the equation 2, x(n) may be a signal in time domain, and X(k) may be a kth frequency component in N-point discrete Fourier transform of x(n).

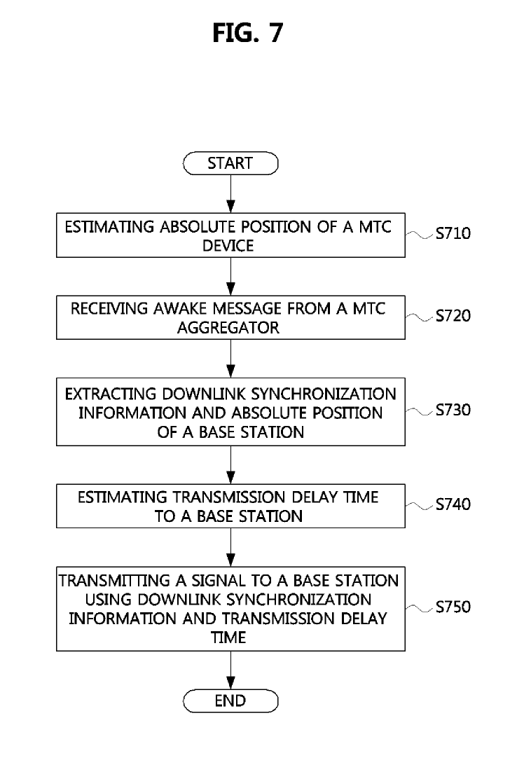

FIG. 7 is a flow chart to explain a method for transmitting data in a MTC device according to an example embodiment of the present invention.

In a method for transmitting data in a MTC device according to an example embodiment of the present invention, a MTC device may estimate absolute position of itself at S710. Then, when the MTC device receives an awake message from a MTC aggregator at S720, the MTC device may extract downlink synchronization information and absolute position of a base station included in the awake message at S730. Then, the MTC device may estimate transmission delay time between itself and the base station using the absolute position of itself and the absolute position of the base station at S740. When there is a signal to be transmitted to the base station, the MTC device may transmit the signal to the base station using the estimated transmission delay time and the extracted downlink synchronization information at S750.

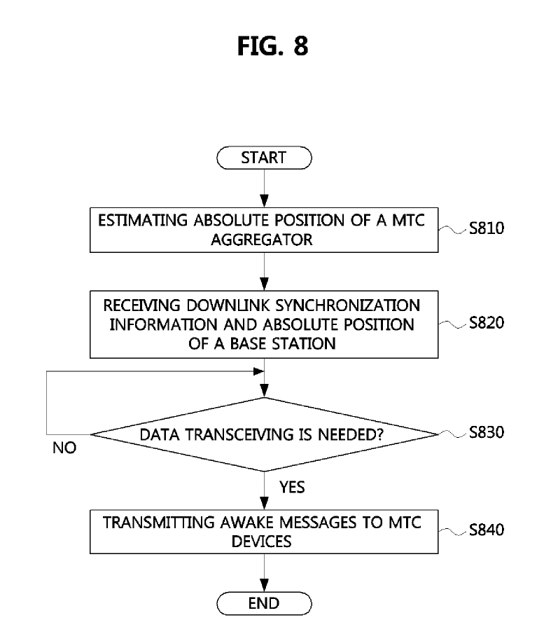

FIG. 8 is a flow chart to explain a method for controlling MTC device according to an example embodiment of the present invention.

A preferable entity for performing the method depicted in FIG. 8 may be a MTC aggregator.

In a method for controlling MTC device according to an example embodiment of the present invention, a MTC aggregator may estimate an absolute position of itself at S810. Then, the MTC aggregator may perform a procedure of establishing downlink synchronization with a base station, and receive information about absolute position of the base station at S820. Also, the MTC aggregator may determine whether data transmission or reception with MTC devices belonging to the same group to which the MTC aggregator is belonging is necessary or not at S830. When data transmission or reception with the MTC devices in the same group is determined to be necessary, the MTC aggregator may transmit awake messages to the MTC devices in the same group at S840.

Here, a case in which data transmission or reception with the MTC devices is necessary may be a case in which a MTC user requests to transmit information to the MTC devices 301 to 303 via the base station 100 connected to a PLMN, or a case in which the MTC aggregator 500 senses an appropriate environmental change.

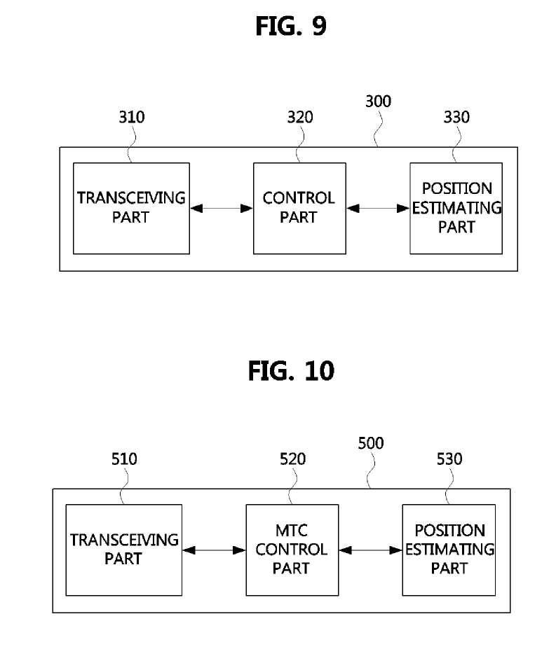

FIG. 9 is a block diagram to illustrate a configuration of MTC device according to an example embodiment of the present invention.

As shown in FIG. 9, a MTC device 300 may comprise a transceiving part 310, a control part 320, and a position estimating part 330.

The position estimating part 330 of the MTC device 300 may estimate an absolute position of the MTC device. The transceiving part 310 may receive awake message from a MTC aggregator and may transmit signal or data to a base station.

The control part 320 may receive the awake message from the transceiving part 310, and estimate transmission delay time between the base station and the MTC device by extracting downlink synchronization information and an absolute positional information of the base station from the awake message. Meanwhile, the control part 320 may maintain a state of the MTC device as a sleep-state before the awake message is received.

The estimated transmission delay time may be used for the transceiving part 310 to transmit signal or data to the base station. When the transceiving part 310 transmits signal or data to the base station, downlink synchronization information included in the awake message may also be used.

FIG. 10 is a block diagram to illustrate a configuration of a MTC aggregator according to an example embodiment of the present invention.

As shown in FIG. 10, a MTC aggregator 500 may comprise a transceiving part 510, a MTC control part 520, and a position estimating part 530.

The position estimating part 530 of the MTC aggregator 500 may estimate an absolute position of the MTC aggregator. The transceiving part 510 may establish downlink synchronization with a base station, and may receive an absolute positional information of the base station from the base station.

The MTC control part 520 may determine whether the MTC aggregator is required to transmit or receive data to or from other MTC device in the same group or not. When the MTC aggregator is required to transmit or receive data to or from MTC device in the same group, the MTC control part 520 may control the transceiving part 510 to transmit an awake message to corresponding MTC device.

According to the present invention explained through the above example embodiments, a problem of uplink interferences between terminals and a base station due to a MTC device, which can be generated in supporting MTC services for a conventional cellular communication system, may be resolved.

While the example embodiments of the present invention and their advantages have been described in detail, it should be understood that various changes, substitutions and alterations may be made herein without departing from the scope of the invention.

What is claimed is:

1. A method for transmitting data in a machine type communication (MTC) device located in a mobile communication system, the method comprising:
estimating an absolute position of the MTC device;
receiving an awake message;
extracting downlink synchronization information and an absolute position of a base station included in the awake message;
estimating a transmission delay time between the MTC device and the base station; and
transmitting signal to the base station based on the transmission delay time and the downlink synchronization information.

2. The method of claim 1, wherein the transmission delay time is calculated using the absolute position of the MTC device and the absolute position of the base station.

3. The method of claim 1, wherein the downlink synchronization information includes information related to frame synchronization and symbol synchronization.

4. The method of claim 1, wherein the MTC device is belonging to a group with at least one MTC device located in a predetermined distance from the MTC device.

5. The method of claim 4, wherein MTC devices belonging to the same group are configured to process data having the same property.

6. The method of claim 4, wherein the mobile communication system is based on an Orthogonal Frequency Division Multiplexing (OFDM).

7. The method of claim 6, wherein the group comprises at least two MTC devices located in a range in which transmission delay time between the at least two MTC devices is shorter than a time length of cyclic prefix (CP).

8. The method of claim 4, wherein the awake message is received from a MTC aggregator belonging to the same group with the MTC device.

9. A machine type communication (MTC) device comprising:
a position estimating part estimating an absolute position of the MTC device; and
a control part estimating a transmission delay time between the MTC device and a base station by extracting downlink synchronization information and an absolute position of the base station included in an awake message when the awake message is received.

10. The machine type communication device of claim 9, further comprising a transceiving part configured to receive the awake message, and transmit signal to the base station using the transmission delay time and the downlink synchronization information.

11. The machine type communication device of claim 9, wherein the control part is configured to maintain a state of the MTC device as a sleep-state before the MTC device receives the awake message.

12. The machine type communication device of claim 9, wherein the awake message is received from a MTC aggregator belonging to the same group with the MTC device.

13. A method for controlling a plurality of machine type communication (MTC) devices belonging to a same group, performed in a MTC aggregator, the method comprising:
estimating an absolute position of the MTC aggregator;
performing a downlink synchronization with a base station, and receiving an absolute position of the base station from the base station; and
transmitting an wake message to at least one of the plurality of MTC devices when data transmission to the at least one of the plurality of MTC devices is required.

14. The method of claim 13, wherein the same group includes a plurality of MTC devices and the MTC aggregator which are located in a predetermined distance from each other.

15. The method of claim 13, wherein the downlink synchronization information includes information related to frame synchronization and symbol synchronization.

16. The method of claim 13, wherein MTC devices belonging to the same group are configure to process data having the same property.

17. The method of claim 13, wherein the base station, the plurality of MTC devices, and the MTC aggregator are based on an Orthogonal Frequency Division Multiplexing (OFDM).

18. The method of claim 17, wherein transmission delay times between the MTC aggregator and each of MTC devices belonging to the same group with the MTC aggregator are shorter than a time length of cyclic prefix (CP).
